(19) United States
(12) Patent Application Publication
(10) Pub. No.: US 2025/0214664 A1
(43) Pub. Date: Jul. 3, 2025

(54) VARIABLE PART CONNECTION AND SEPARATION APPARATUS AND VARIABLE PART CONNECTION AND SEPARATION SYSTEM USING THE SAME

(71) Applicants: HYUNDAI MOTOR COMPANY, Seoul (KR); Kia Corporation, Seoul (KR)

(72) Inventors: Jaeseung LEE, Hwaseong-si (KR); Jin Ho HWANG, Hwaseong-si (KR); Won Ki SONG, Hwaseong-si (KR); Hyungsik CHOI, Hwaseong-si (KR)

(73) Assignees: HYUNDAI MOTOR COMPANY, Seoul (KR); Kia Corporation, Seoul (KR)

(21) Appl. No.: 18/958,679

(22) Filed: Nov. 25, 2024

(30) Foreign Application Priority Data
Dec. 29, 2023 (KR) 10-2023-0197133

(51) Int. Cl. B62D 65/02; B62D 27/06; B62D 63/02; F16B 1/00

(52) U.S. Cl. CPC B62D 65/024; B62D 27/06; B62D 63/025; F16B 1/00; F16B 2200/83

(57) ABSTRACT

A variable part connection and separation apparatus includes a magnetic controller configured for forming or releasing an engaging magnetic field between a frame and a variable part by selectively supplying a control magnetic field to a lower magnetic engaging unit mounted on the frame including a fixed part mounted on the frame and the variable part selectively engaged to the frame, and a lifter that separates the variable part from the frame or sets the variable part to the frame.

### CROSS-REFERENCE TO RELATED APPLICATION

The present application claims priority to Korean Patent Application No. 10-2023-0197133 filed on Dec. 29, 2023, the entire contents of which is incorporated herein for all purposes by this reference.

### BACKGROUND OF THE PRESENT DISCLOSURE

### Field of the Present Disclosure

The present disclosure relates to a variable part connection and separation apparatus configured for changing the type according to the purpose of use of a vehicle, and a variable part connection and separation system using the same.

### Description of Related Art

Recently, the vehicle industry is introducing a new concept of future mobility vision for realizing a human-centered, dynamic future city. One of these future mobility solutions is a Purpose Built Vehicle (PBV) as purpose-based mobility.

A PBV may be an example of an electric vehicle (EV)-based environment-friendly mobile vehicle. The present PBV can provide various customized services to users while moving from the starting point to the destination in an unmanned autonomous driving method.

PBV may be configured in various forms depending on the type of customized service. For example, PBV may be used as a hailing type vehicle that configures a cabin to transport occupants. Furthermore, the PBV may be utilized as a cab type vehicle with a cabin configured only in the front part of the upper body, or as a delivery type vehicle with a cabin configured in the front part of the upper body and a luggage compartment configured in the rear part.

However, if the body type may be easily changed according to the vehicle's intended use, the entire usability of the vehicle may be further increased.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a variable part connection and separation apparatus and a variable part connection and separation system including the same, which can increase the utility value of a vehicle by easily connecting and separating variable parts according to the intended use of the vehicle.

Furthermore, the present disclosure attempts to provide a variable part connection and separation apparatus and a variable part connection and separation system including the same, which can simplify the entire configuration and rapidly perform connection and separation of variable parts to increase user convenience.

A variable part connection and separation apparatus according to various exemplary embodiments of the present disclosure may include a magnetic controller for forming or releasing an engaging magnetic field between a frame and a variable part by selectively supplying a control magnetic field to a lower magnetic engaging unit mounted on the frame including a fixed part mounted on the frame and the variable part selectively engaged to the frame, and a lifter that separates the variable part from the frame or sets the variable part to the frame.

The variable part connection and separation apparatus according to various exemplary embodiments of the present disclosure may further include a lifter moving part engaged to the lifter for moving the lifter.

The magnetic controller may be mounted on the lifter.

The lifter may include a lift pillar, and provided to be movable upwards and downwards on the lift pillar, and the magnetic controller may be mounted on the lift arm.

The lifter may further include a lift control motor, a lift pillar lead screw mounted on the lift pillar, connected to the list control motor, and rotated by the lift control motor, and a lift block which is connected to the lift arm, engaged to the lift pillar lead screw, and moves up and down by the rotation of the lift pillar lead screw.

The magnetic controller may include a controller coil that supplies a selectively controlled magnetic field to the lower magnetic engage unit, and a coil holder on which the controller coil is mounted.

The magnetic controller may further include a holder rotation part that selectively rotates the coil holder to be adjacent to the lower magnetic engage unit or away from the lower magnetic engage unit.

The holder rotation part may include a lift arm hinge mounted on a lift arm which is provided to be able to move up and down on the lift pillar of the lifter, a coil holder hinge mounted on the coil holder, a rotation part connecting pin connecting the lift arm hinge and the coil holder hinge, and a rotation part motor that is connected to the rotation part connecting pin and selectively rotates the rotation part connecting pin.

The lifter moving part may include a guide motor, a guide motor lead screw connected to the guide motor, a lifter plate supporting the lifter, and a guide slide connected to the lifter plate and engaged with the guide motor lead screw to move the lifter according to the rotation of the guide motor lead screw.

The lifter moving part may further include a guide plate on which the guide motor is mounted, and a guide rail mounted on first and second sides of the guide plate to guide the movement of the lifter plate.

The lifter moving part may further include a center guide rail mounted between the two guide rails and guiding the movement of the guide slide.

A variable part connection and separation system according to various exemplary embodiments of the present disclosure may include a frame on which a fixed part is mounted, a variable part selectively coupled with the frame and the fixed part, a lower magnetic engage unit mounted on the frame and the variable part, and a magnetic controller that selectively supplies a control magnetic field to the lower magnetic engage unit to form or release an engaging magnetic field of the frame and the variable part.

The lower magnetic engage unit may include an engage unit housing, a fixed magnet mounted on the engage unit housing, a control magnet rotatably mounted on the engage unit housing, and a frame lower plate mounted on the frame, with a magnetic field passage formed in the lower position of the control magnet, and on which the engage unit housing is mounted.

The magnetic controller may include a controller coil which selectively supplies a control magnetic field to the control magnet through the magnetic field passage.

The variable part connection and separation system according to various exemplary embodiments of the present disclosure may further include a lifter that separates the variable part from the frame or sets the variable part to the frame.

The variable part connection and separation system according to various exemplary embodiments of the present disclosure may further include a lifter moving part engaged to the lifter for moving the lifter.

The lower magnetic engage unit may include an engage unit housing mounted on the variable part, a fixed magnet mounted on the engage unit housing, a control magnet rotatably mounted on the engage unit housing, and a frame lower plate mounted on the frame and including a magnetic field passage formed in the lower position of the control magnet.

According to an exemplary embodiment of a variable part connection and separation apparatus and a variable part connection and separation system including the same, variable parts may be easily connected and separated, increasing the usability of a vehicle and enhancing user convenience.

Furthermore, the effects which may be obtained or expected from embodiments of the present disclosure are directly or implicitly included in the detailed description of the exemplary embodiments of the present disclosure. That is, various effects predicted according to exemplary embodiments of the present disclosure will be included in the detailed description to be provided later.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a side view of a vehicle body to which a variable part connection and separation apparatus according to various exemplary embodiments of the present disclosure may be applied.

FIG. 2 is a perspective view showing the variable part connection and separation apparatus according to an exemplary embodiment of the present disclosure.

FIG. 3 is a rear view showing the variable part connection and separation apparatus according to an exemplary embodiment of the present disclosure.

FIG. 4 is a perspective view of a magnetic controller and a lift pillar of the variable part connection and separation apparatus according to an exemplary embodiment of the present disclosure.

FIG. 5 is a cross-sectional view of the magnetic controller and lift pillar of the variable part connection and separation apparatus according to an exemplary embodiment of the present disclosure.

FIG. 6 is a side view showing the operation state of the magnetic controller of the variable part connection and separation apparatus according to an exemplary embodiment of the present disclosure.

FIG. 7 is a perspective view showing the operation state of the magnetic controller of the variable part connection and separation apparatus according to an exemplary embodiment of the present disclosure.

FIG. 8 is a side view showing the operation completion state of the magnetic controller of the variable part connection and separation apparatus according to an exemplary embodiment of the present disclosure.

FIG. 9 is a perspective view showing the operation completion state of the magnetic controller of the variable part connection and separation apparatus according to an exemplary embodiment of the present disclosure.

FIG. 10 is a cross-sectional view along the line X-X of FIG. 2.

FIG. 11 is a cross-sectional view along line XI-XI of FIG. 2.

FIG. 12, FIG. 13, FIG. 14, FIG. 15 and FIG. 16 are drawings showing the operation of a variable part connection and separation apparatus according to an exemplary embodiment of the present disclosure.

FIG. 17 is a drawing showing an operation of a variable part connection and separation apparatus according to a modified embodiment of the present disclosure.

FIG. 18 and FIG. 19 are drawings illustrating variable part transfer of the variable part connection and separation apparatus according to exemplary embodiments of the present disclosure.

It may be understood that the appended drawings are not necessarily to scale, presenting a somewhat simplified representation of various features illustrative of the basic principles of the present disclosure. The specific design features of the present disclosure as included herein, including, for example, predetermined dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, with reference to the appended drawings, various exemplary embodiments of the present disclosure will be described in detail so that those skilled in the art can easily implement the present disclosure.

As those skilled in the art would realize, the described embodiments may be modified in various different ways, all without departing from the spirit or scope of the present disclosure.

To clearly explain an exemplary embodiment of the present disclosure, parts irrelevant to the description are omitted, and the same reference numerals are used for identical or similar components throughout the specification.

The size and thickness of each component shown in the drawings are arbitrarily shown for convenience of explanation, and the present disclosure is not necessarily limited to what is shown in the drawings. To clearly express various parts and areas, the thickness is shown by enlarging it.

Furthermore, the names of the components in the detailed description below are distinguished as first, second, etc., to distinguish them as they include the same relationship, and the description below is not necessarily limited to that order.

Throughout the specification, whenever a part is said to include or comprises a certain component, this does not mean that it excludes other components, but rather that it may include other components, unless otherwise stated.

Additionally, terms such as “means”, “part”, “unit”, etc., described in the specification mean a comprehensive unit that is configured to perform at least one function or operation.

When we say that a part, such as a layer, membrane, region, or plate, is “on top of” another part, this includes not only cases where it is directly on top of the other part, but also cases where there are other parts in between.

In contrast, when an element is referred to as being “directly on” another element, there are no intervening elements present.

In the present specification, the term ‘connected’ indicates a physical relationship between two components in which the components are directly connected to each other by welding, rivets, Self Piercing Rivet (SPR), Flow Drill Screw (FDS), structural adhesive, etc., or indirectly connected through one or more intermediate components.

As used herein, ‘vehicle’, ‘vehicular’, ‘automotive’ or other similar terms as used herein generally refer to passenger vehicles, sports cars, sports utility vehicles (SUVs), buses, trucks, and various commercial vehicles including passenger vehicles, hybrid vehicles, electric vehicles, hybrid electric vehicles, electric vehicle-based Purpose Built Vehicles (PBVs), hydrogen-powered vehicles and other alternative fuel vehicles (e.g., other than petroleum fuel derived from resources).

In the present specification, the ‘front to rear direction of the vehicle body’ may be defined as the longitudinal direction of the vehicle body, the ‘vehicle width direction’ may be defined as the left and right direction of the vehicle body, and the ‘up-and-down direction’ may be defined as the height direction of the vehicle body.

In the present specification, ‘upper end’, ‘upper portion’, or ‘upper surface’ of a component indicates an end, portion, or surface of a component that is relatively upper in the drawing, and ‘lower end’, ‘lower portion’, or ‘lower surface’ of a component indicates an end, portion, or surface of a component that is relatively lower in the drawing.

Furthermore, in the present specification, an end of a component (e.g., one end or another (other) end, etc.) denotes an end of a component in any one direction, and an end portion of the component (e.g., one end portion) or other (another) end portion, etc.) denotes a portion of a component that includes that end.

An exemplary embodiment will hereinafter be described in detail with reference to the accompanying drawings.

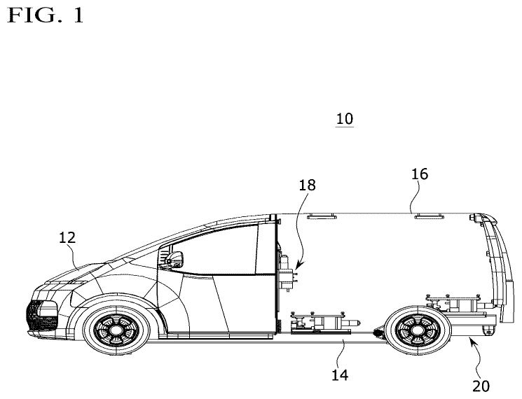

FIG. 1 is a side view of a vehicle body to which a variable part connection and separation apparatus according to various exemplary embodiments of the present disclosure may be applied.

Referring to FIG. 1, a vehicle body 10 to which a variable part connection and separation apparatus according to various exemplary embodiments of the present disclosure may be applied includes a frame 14 including a fixed part 12 mounted thereon and a variable part 16 selectively connectable to the frame 14.

The fixed part 12 may include, for example, a driver's seat.

The variable part 16 may be a hailing type cabin for transporting occupants, or a delivery type configuration for transporting cargo with a luggage compartment.

The vehicle body 10 to which the variable part connection and separation apparatus according to various exemplary embodiments of the present disclosure may be applied may include an upper magnetic engage unit 18 that selectively connects and separates the fixed part 12 and the variable part 16, and a lower magnetic engage unit 20 that selectively connects and separates the frame 14 and the variable part 16.

The upper magnetic engage unit 18, which combines the fixed part 12 and the variable part 16, may be configured to engage and release by mechanical actuation, or may be configured to engage or release by applying magnetic force.

The lower magnetic engage unit 20 may be a configuration that combines or releases the frame 14 and the variable part 16 by applying a magnetic force. For convenience of understanding, it is referred to as the lower magnetic engage unit 20 hereinafter.

The lower magnetic engage unit 20 is mounted on the frame 14 and the variable part 16, and its specific operation will be described later.

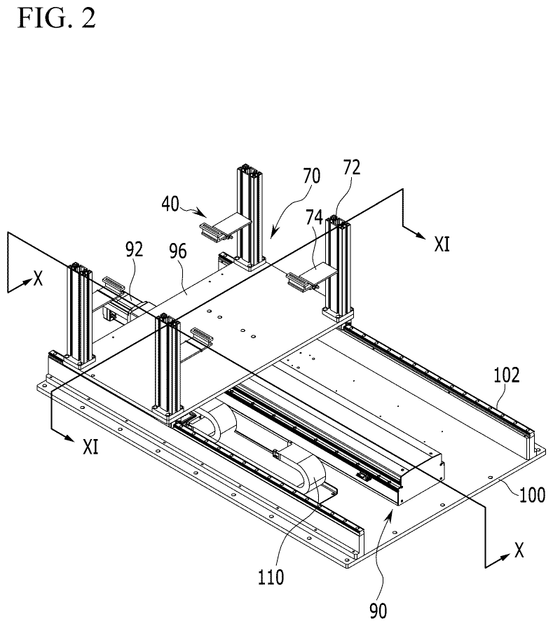

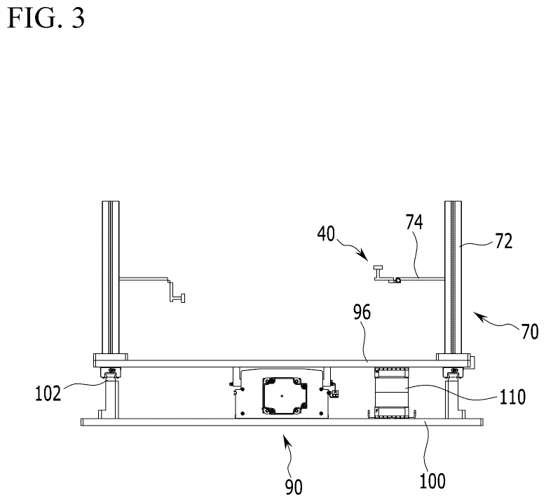

FIG. 2 is a perspective view showing the variable part connection and separation apparatus according to an exemplary embodiment of the present disclosure, and FIG. 3 is a rear view showing the variable part connection and separation apparatus according to an exemplary embodiment of the present disclosure.

Referring to FIG. 2 and FIG. 3, the variable part connection and separation apparatus according to various exemplary embodiments of the present disclosure may include a magnetic controller 40 for selectively supplying a control magnetic field to the lower magnetic engage unit 20 to form or release an engaging magnetic field between the frame 14 and the variable part 16, and a lifter 70 for separating the variable part 16 from the frame 14 or settling the variable part 16 on the frame 14.

As illustrated in the drawing, the magnetic controller 40 may be configured to be mounted on the lifter 70, but is not limited thereto, and may be configured to be mounted on a lifter moving part described below, or may be positioned adjacent to the lifter 70 to form or release an engaging magnetic field of the frame 14 and the variable part 16.

A cableveyor 110 (or cable carrier) may be provided to control the operation of the lifter 70 and the lower magnetic engage unit 20 and to supply power thereto.

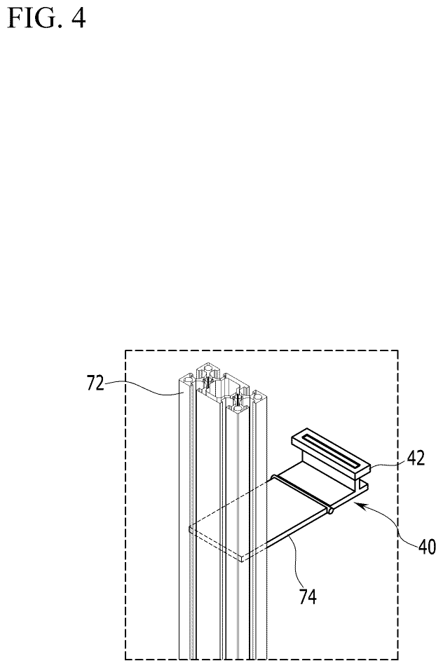

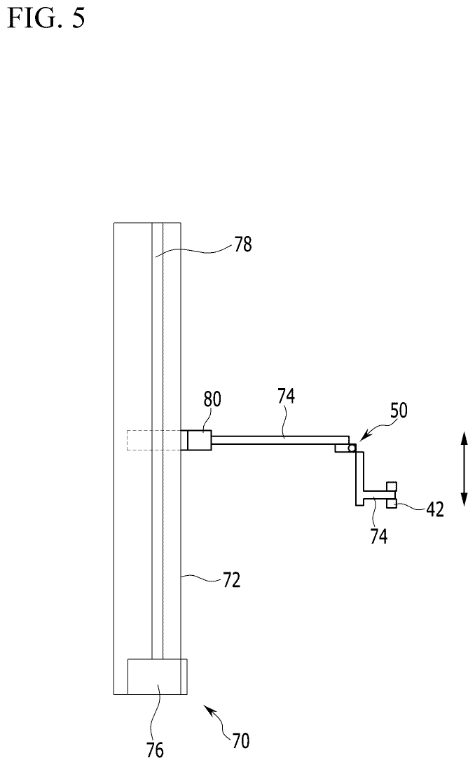

FIG. 4 is a perspective view of a magnetic controller and a lift pillar of the variable part connection and separation apparatus according to an exemplary embodiment of the present disclosure, and FIG. 5 is a cross-sectional view of the magnetic controller and lift pillar of the variable part connection and separation apparatus according to an exemplary embodiment of the present disclosure.

Referring to FIG. 2 to FIG. 5, the lifter 70 may include a lift pillar 72, and a lift arm 74 provided to be movable upwards and downwards on the lift pillar 72.

Additionally, the lifter 70 may further include a lift control motor 76, a lift pillar lead screw 78 mounted on the lift pillar 72 and rotated by the lift control motor 76, and a lift block 80 coupled to the lift arm 74 and engaged with the lift pillar lead screw 78 to move up and down by the rotation of the lift pillar lead screw 78.

When the lift pillar lead screw 78 rotates by operation of the lift control motor 76, the lift block 80 engaged with the lift pillar lead screw 78 moves up and down, and the lift arm 74 coupled with the lift block 80 also moves up and down.

The lift arm 74 is configured to support the variable part 16, and the variable part 16 may be separated from the frame 14 or the variable part 16 may be provided on the frame 14 depending on the up and down movement of the lift arm 74.

The magnetic controller 40 may be mounted on the lift arm 74.

That is, the magnetic controller 40 is mounted on the lift arm 74 and may approach or move away from the lower magnetic engage unit 20 depending on the up and down movement of the lift arm 74.

The present configuration simplifies the configuration of the variable part connection and separation apparatus according to an exemplary embodiment of the present disclosure, and enables quick connection and separation of the variable part 16 and the frame 14.

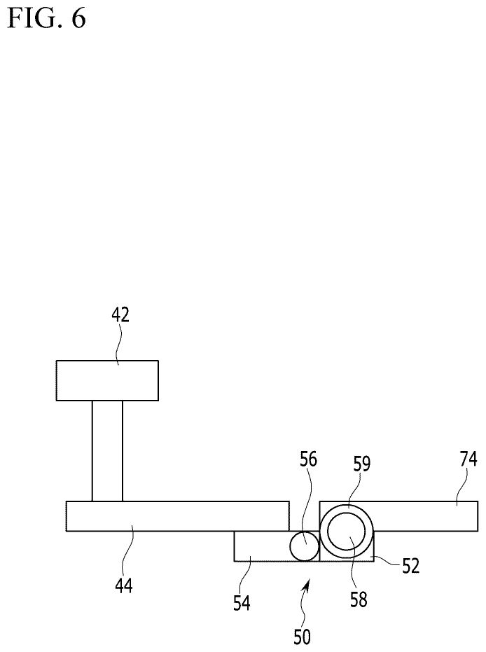

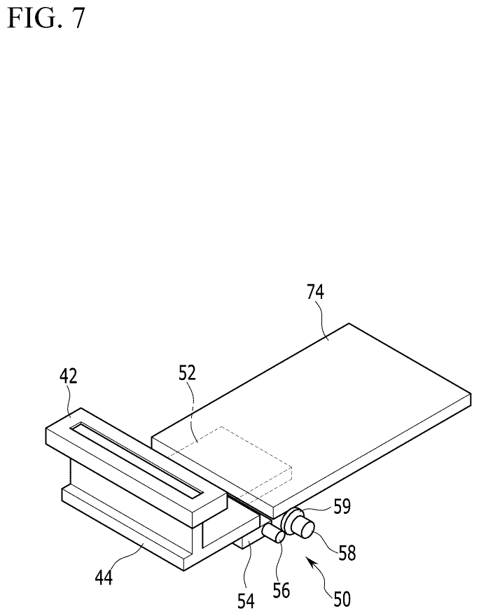

FIG. 6 is a side view showing the operation state of the magnetic controller of the variable part connection and separation apparatus according to an exemplary embodiment of the present disclosure, and FIG. 7 is a perspective view showing the operation state of the magnetic controller of the variable part connection and separation apparatus according to an exemplary embodiment of the present disclosure.

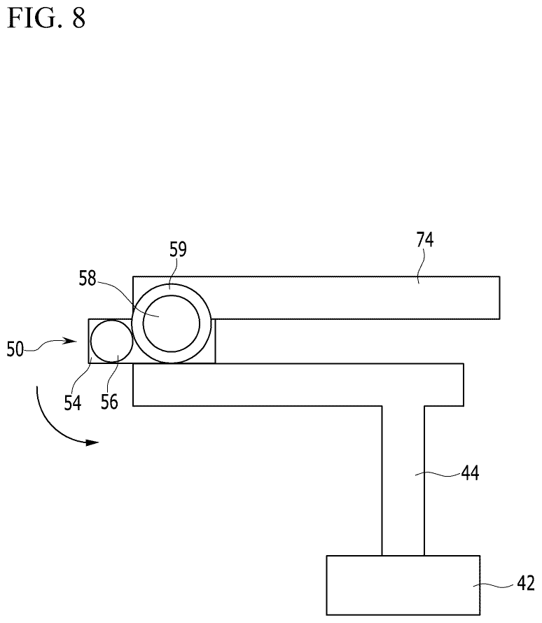

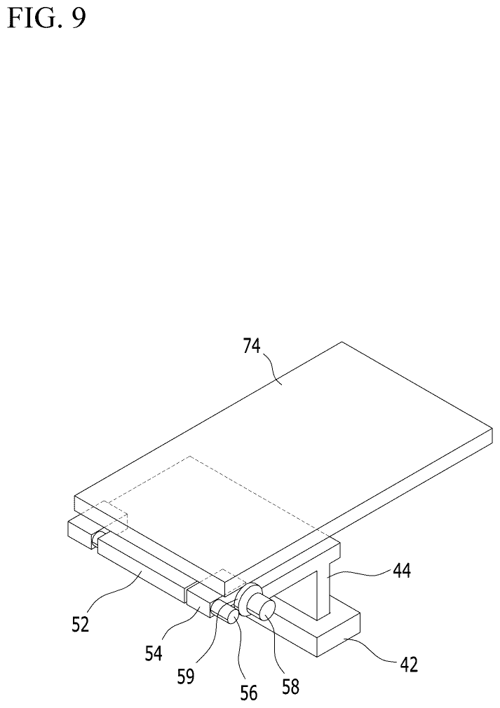

FIG. 8 is a side view showing the operation completion state of the magnetic controller of the variable part connection and separation apparatus according to an exemplary embodiment of the present disclosure, and FIG. 9 is a perspective view showing the operation completion state of the magnetic controller of the variable part connection and separation apparatus according to an exemplary embodiment of the present disclosure.

Referring to FIG. 6, FIG. 7, and FIG. 8, the magnetic controller 40 may include a controller coil 42 for selectively supplying a control magnetic field to the lower magnetic engage unit 20, and a coil holder 44 on which the controller coil 42 is mounted.

The magnetic controller 40 may further include a holder rotation part 50 that selectively rotates the coil holder 44 to bring the controller coil 42 closer to the lower magnetic engage unit 20 or away from the lower magnetic engage unit 20.

The holder rotation part 50 may include a lift arm hinge 52 mounted on the lift arm 74 which is movable upwards and downwards on the lift pillar 72 of the lifter 70, a coil holder hinge 54 mounted on the coil holder 44, a rotation part connecting pin 56 that connects the lift arm hinge 52 and the coil holder hinge 54, and a rotation part motor 58 that selectively rotates the rotation part connecting pin 56.

A motor gear 59 is mounted on the rotation part motor 58, and the motor gear 59 is engaged with the rotation part connecting pin 56, so that the lift arm 74 may rotate around the rotation part connecting pin 56 according to the rotation of the motor gear 59.

As shown in FIG. 6 and FIG. 7, the controller coil 42 may be brought into contact with the lower magnetic engage unit 20 by the upward operation of the lift arm 74 while the coil holder 44 is positioned at the upper side thereof.

Furthermore, after the controller coil 42 performs the engage or release operation of the lower magnetic engage unit 20, the coil holder 44 may be rotated by operation of the rotation part motor 58 as shown in FIG. 8 and FIG. 9.

When the coil holder 44 rotates and is positioned below the lift arm 74, interference with the coil holder 44 may be prevented when the lift arm 74 separates the variable part 16 from the frame 14 or secures the variable part 16 to the frame 14.

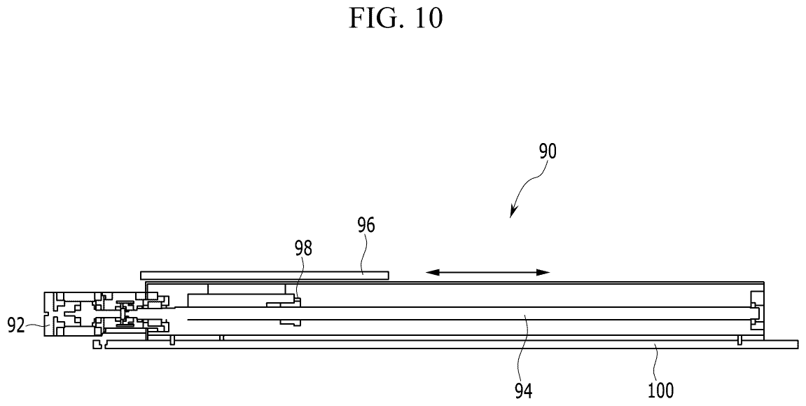

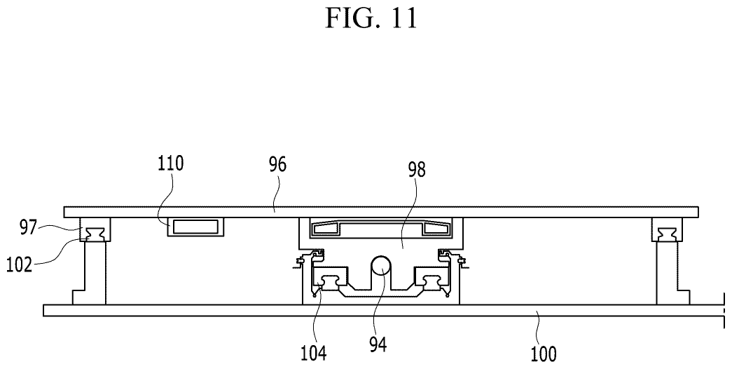

FIG. 10 is a cross-sectional view along the line X-X of FIG. 2, and FIG. 11 is a cross-sectional view along line XI-XI of FIG. 2.

Referring to FIG. 2, FIG. 3, FIG. 10 and FIG. 11, an exemplary embodiment of the variable part connection and separation apparatus may further include a lifter moving part 90 for moving the lifter 70.

The lifter moving part 90 may include a guide motor 92, a guide motor lead screw 94 connected to the guide motor 92, a lifter plate 96 supporting the lifter 70, and a guide slide 98 connected to the lifter plate 96 and engaged with the guide motor lead screw 94 to move the lifter 70 according to the rotation of the guide motor lead screw 94.

The lifter moving part 90 may further include a guide plate 100 including the guide motor 92 mounted thereon, and guide rails 102 mounted on both sides of the guide plate 100 to guide the movement of the lifter plate 96.

The guide rail 102 may support the plate rail 97 mounted on the lower portion of the lifter plate 96.

The lifter moving part 90 may further include a center guide rail 104 mounted between the two guide rails 102 to guide the movement of the guide slide 98.

Referring to FIG. 1 to FIG. 11, the variable part connection and separation system according to an exemplary embodiment of the present disclosure includes the vehicle body 10 and the magnetic controller 40 including the frame 14 including the fixed part 12 mounted thereon, the variable part 16 selectively coupled to the frame 14 and the fixed part 12, and the lower magnetic engage unit 20 mounted to the frame 14 and the variable part 16.

Additionally, the variable part connection and separation system according to various exemplary embodiments of the present disclosure may further include the lifter 70 for separating the variable part 16 from the frame 14 or for setting the variable part 16 to the frame 14.

Additionally, the variable part connection and separation system according to various exemplary embodiments of the present disclosure may further include the lifter moving part 90 that moves the lifter 70.

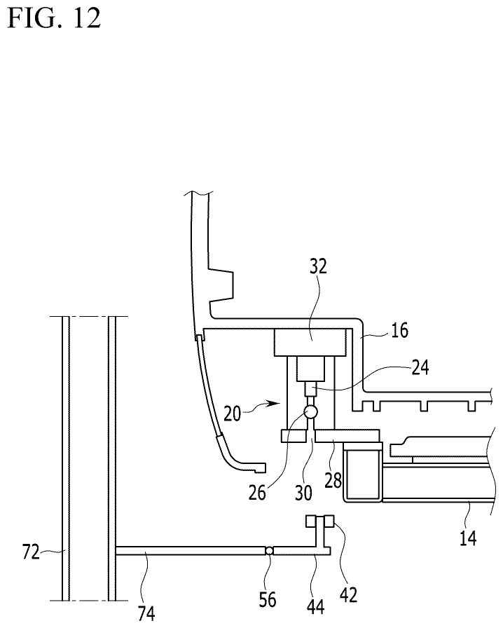

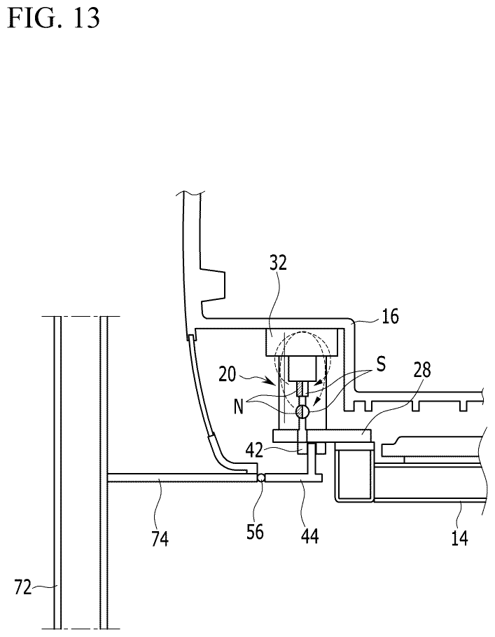

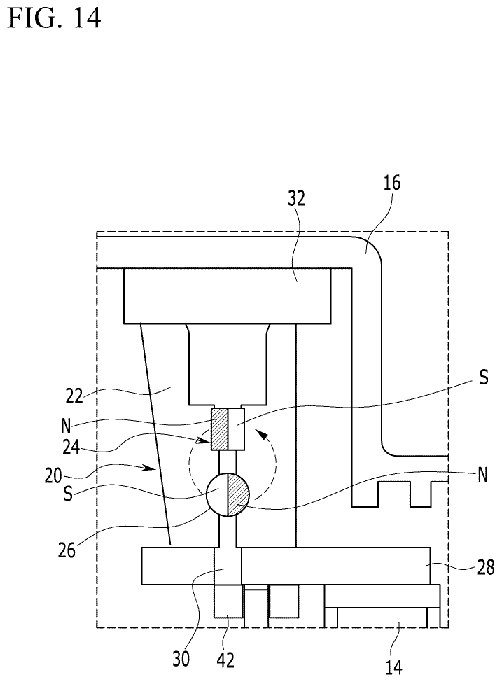

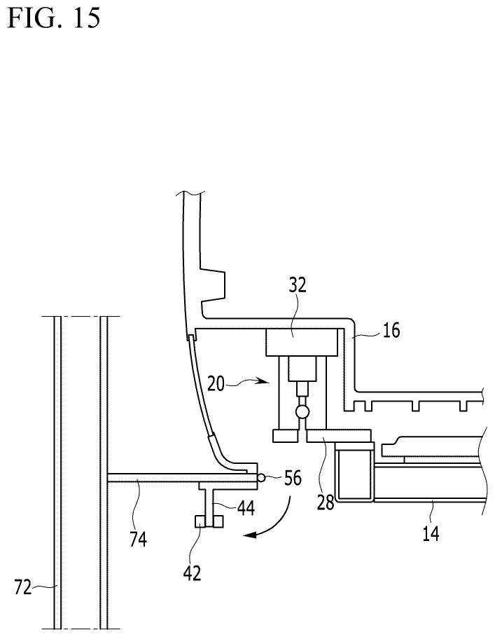

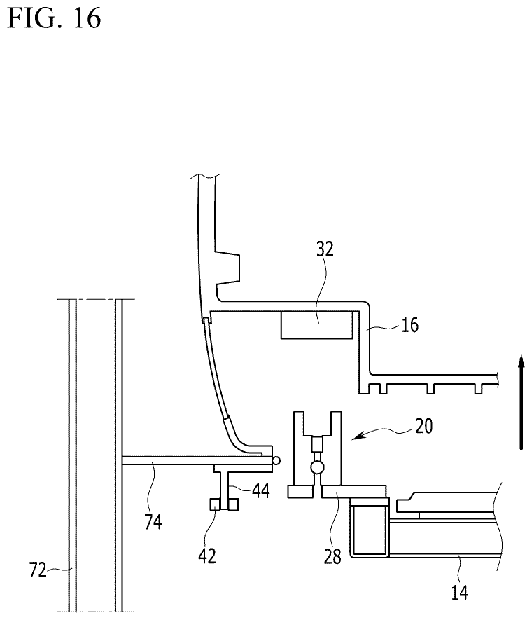

FIG. 12, FIG. 13, FIG. 14, FIG. 15 and FIG. 16 are drawings showing the operation of a variable part connection and separation apparatus according to an exemplary embodiment of the present disclosure.

Referring to FIG. 12, FIG. 13, FIG. 14, FIG. 15 and FIG. 16, the lower magnetic engage unit 20 may include an engage unit housing 22, a fixed magnet 24 mounted on the engage unit housing 22, a control magnet 26 rotatably mounted on the engage unit housing 22, and a frame lower plate 28 mounted on the frame 14 and including a magnetic field passage 30 formed in a lower position of the control magnet 26.

The engage unit housing 22 may be secured to the frame lower plate 28.

The controller coil 42 of the magnetic controller 40 may selectively supply the control magnetic field to the control magnet 26 through the magnetic field passage 30.

Referring to FIG. 12 and FIG. 13, the vehicle body 10 is introduced to replace the variable part 16, with the frame 14 and the variable part 16 being coupled by the engaging magnetic field of the lower magnetic engage unit 20.

When the lift control motor 76 is driven with the coil holder 44 positioned at the upper position by operation of the rotation part motor 58, the controller coil 42 is brought into contact with the magnetic field passage 30 of the lower magnetic engage unit 20 by the upward operation of the lift arm 74.

As shown in FIG. 13, the fixed magnet 24 and the control magnet 26 are disposed with their polarities in the same direction thereof.

For example, as shown in the drawing, the fixed magnet 24 and the control magnet 26 may be disposed with the N pole on the left side of the drawing and the S pole on the right side of the drawing.

Since the polarities of the fixed magnet 24 and the control magnet 26 are in the same direction, the same magnetic force direction is formed, for example, the same magnetic force direction in the clockwise direction is formed as shown in the drawing.

A variable part armature 32 is mounted on the lower part of the variable part 16, and the variable part armature 32 and the lower magnetic engage unit 20 are coupled by the magnetic force of the fixed magnet 24 and the control magnet 26.

At the present time, the lower magnetic engage unit 20 is coupled to the frame 14.

As shown in FIG. 14, when the controller coil 42 momentarily supplies a control magnetic field, the control magnet 26, which is rotatably mounted in the engage unit housing 22, rotates.

When the control magnetic field of the controller coil 42 is interrupted, the control magnet 26 is disposed to include a polarity in a direction different from that of the fixed magnet 24 by the magnetic force of the fixed magnet 24.

For example, the control magnet 26 may be positioned so that the N pole is to the right of the drawing and the S pole is to the left of the drawing.

Accordingly, as shown by the arrow in FIG. 14, the magnetic force direction is formed in the counterclockwise direction, forming a closed magnetic field of the control magnet 26 and the fixed magnet 24.

Therefore, the engaging magnetic field of the variable part armature 32 and the lower magnetic engaging unit 20 is released.

Referring to FIG. 15, the coil holder 44 rotates by operation of the holder rotation part 50, and as shown in FIG. 16, by operation of the lifter 70, the lift arm 74 moves the separated variable part 16 upwards.

At the present time, the coil holder 44 rotates by operation of the holder rotation part 50, so that the movement of the lift arm 74 is not interfered with.

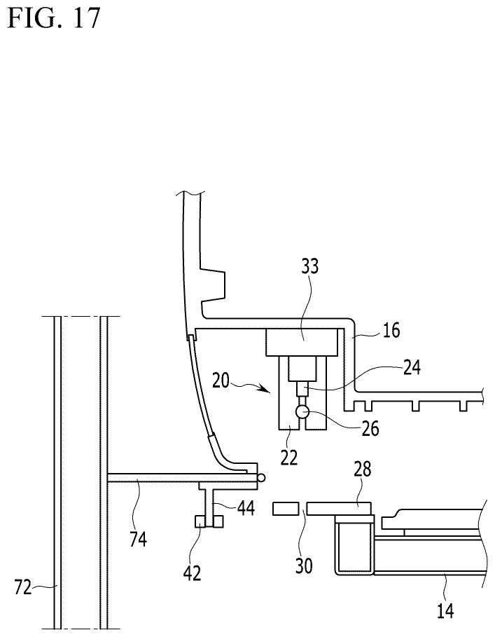

FIG. 17 is a drawing showing an operation of a variable part connection and separation apparatus according to a modified embodiment of the present disclosure.

In explaining the configuration of a variable part connection and separation apparatus according to a modified embodiment of the present disclosure of FIG. 17, the same or similar configurations described in FIG. 1 to FIG. 16 are referred to by the same or similar drawing reference numbers, and repeated descriptions are omitted for the convenience of understanding.

Compared to an exemplary embodiment illustrated in FIG. 12, FIG. 13, FIG. 14, FIG. 15 and FIG. 16, in a modified embodiment illustrated in FIG. 17, the frame lower plate 28 is configured as the variable part armature 32.

An engage unit bracket 33 coupled with the engage unit housing 22 is mounted on the lower portion of the variable part 16, and the engage unit housing 22 is separated from the frame lower plate 28.

When the fixed magnet 24 and the control magnet 26 are disposed with their polarities in the same direction, an engaging magnetic force between the fixed magnet 24 and the control magnet 26 is formed, and the frame lower plate 28 and the lower magnetic engaging unit 20 are coupled.

And, as explained above, when the controller coil 42 momentarily supplies a control magnetic field and release it, the control magnet 26 rotates and the control magnet 26 is positioned so that its polarity faces a different direction from that of the fixed magnet 24.

Therefore, a closed magnetic field is formed between the control magnet 26 and the fixed magnet 24, and the engaging magnetic field between the frame lower plate 28 and the lower magnetic engaging unit 20 is released.

In the modified embodiment of the present disclosure of FIG. 17, the configuration which is coupled with the engaging unit housing 22 is changed to the frame lower plate 28, and the operation of the lower magnetic engaging unit 20, etc. is the same, so a detailed description is omitted.

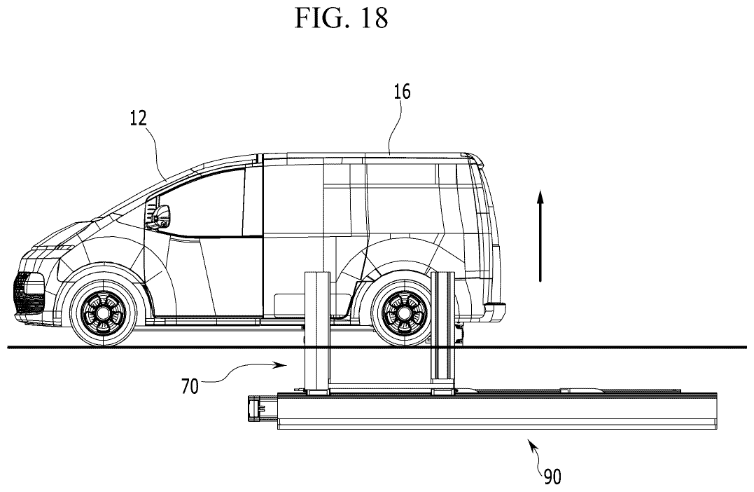

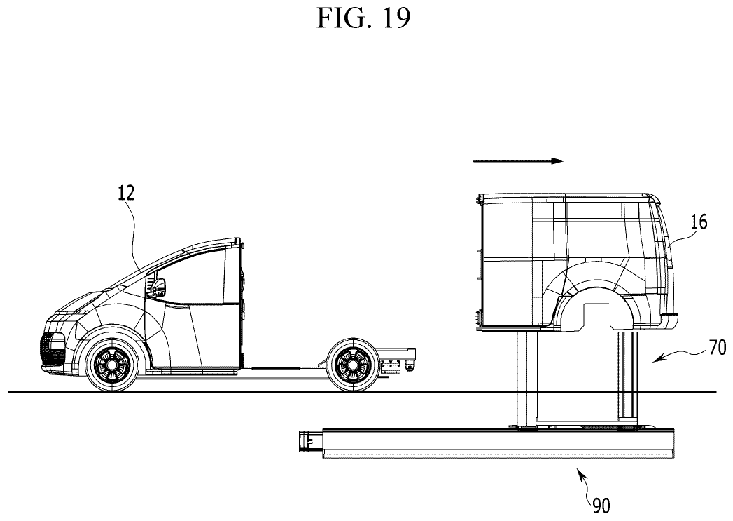

FIG. 18 and FIG. 19 are drawings illustrating variable part transfer of the variable part connection and separation apparatus according to exemplary embodiments of the present disclosure.

As shown in FIG. 18, when the frame 14 and the variable part 16 are separated, the lift arm 74 moves the separated variable part 16 upward, and as shown in FIG. 19, the variable part 16 is moved by operation of the lifter moving part 90.

Thereafter, the variable part 16 to be changed is moved to the joining position of the frame 14 by operation of the lifter moving part 90, and the lift arm 74 places the variable part 16 to be changed on the frame 14.

Afterwards, the variable part and the frame are combined by operation of the magnetic controller 40.

At the present time, the magnetic field of the controller coil 42 may include a polarity opposite to the magnetic field at the time of release described above.

As described above, according to various exemplary embodiments of the variable part connection and separation apparatus and the variable part connection and separation system including the same, the variable parts may be easily connected and separated, increasing the usability of the vehicle and enhancing user convenience.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A variable part connection and separation apparatus comprising:
a magnetic controller configured for forming or releasing an engaging magnetic field between a frame and a variable part by selectively supplying a control magnetic field to a magnetic engaging unit mounted on the frame including a fixed part mounted on the frame and the variable part selectively engaged to the frame; and
a lifter that separates the variable part from the frame or sets the variable part to the frame.

2. The variable part connection and separation apparatus of claim 1, further includes a lifter moving part engaged to the lifter for moving the lifter.

3. The variable part connection and separation apparatus of claim 1, wherein the magnetic controller is mounted on the lifter.

4. The variable part connection and separation apparatus of claim 3,
wherein the lifter includes:
a lift pillar; and
a lift arm engaged to the lift pillar and movable upwards and downwards on the lift pillar,
wherein the magnetic controller is mounted on the lift arm.

5. The variable part connection and separation apparatus of claim 4, wherein the lifter further includes:
a lift control motor;
a lift pillar lead screw mounted on the lift pillar, connected to the list control motor, and rotated by the lift control motor; and
a lift block which is connected to the lift arm, engaged to the lift pillar lead screw, and moves up and down along the lift pillar by the rotation of the lift pillar lead screw.

6. The variable part connection and separation apparatus of claim 1, wherein the magnetic controller includes:
a controller coil that supplies a selectively controlled magnetic field to the magnetic engage unit; and
a coil holder on which the controller coil is mounted.

7. The variable part connection and separation apparatus of claim 6, wherein the magnetic controller further includes a holder rotation part that selectively rotates the coil holder to be adjacent to the magnetic engage unit or away from the magnetic engage unit.

8. The variable part connection and separation apparatus of claim 7, wherein the holder rotation part includes:
a lift arm hinge mounted on a lift arm which is provided to move up and down on a lift pillar of the lifter;
a coil holder hinge mounted on the coil holder;
a rotation part connecting pin connecting the lift arm hinge and the coil holder hinge; and
a rotation part motor that is connected to the rotation part connecting pin and selectively rotates the rotation part connecting pin.

9. The variable part connection and separation apparatus of claim 2, wherein the lifter moving part includes:
a guide motor;
a guide motor lead screw connected to the guide motor;
a lifter plate supporting the lifter; and
a guide slide connected to the lifter plate and engaged with the guide motor lead screw to move the lifter according to rotation of the guide motor lead screw.

10. The variable part connection and separation apparatus of claim 9, wherein the lifter moving part further includes:
a guide plate on which the guide motor is mounted; and
first and second guide rails mounted on first and second sides of the guide plate respectively to guide movement of the lifter plate.

11. The variable part connection and separation apparatus of claim 10, wherein the lifter moving part further includes a center guide rail mounted between the first and second guide rails mounted on first and second sides of the guide plate and guiding movement of the guide slide.

12. A variable part connection and separation system comprising:
a frame on which a fixed part is mounted;
a variable part selectively coupled with the frame and the fixed part;
at least one magnetic engage unit mounted on the frame and the variable part; and
a magnetic controller that selectively supplies a control magnetic field to the at least one magnetic engage unit to form or release an engaging magnetic field of the frame and the variable part.

13. The variable part connection and separation system of claim 12, wherein the at least one magnetic engage unit includes:
an engage unit housing;
a fixed magnet mounted on the engage unit housing;
a control magnet rotatably mounted on the engage unit housing; and
a frame lower plate mounted on the frame, with a magnetic field passage formed in a lower position of the control magnet, and on which the engage unit housing is mounted.

14. The variable part connection and separation system of claim 13, wherein the magnetic controller includes a controller coil which selectively supplies the control magnetic field to the control magnet through the magnetic field passage.

15. The variable part connection and separation system of claim 14, wherein the magnetic controller further includes:
a coil holder on which the controller coil is mounted.

16. The variable part connection and separation system of claim 15, wherein the magnetic controller further includes a holder rotation part that selectively rotates the coil holder to be adjacent to the at least one magnetic engage unit or away from the at least one magnetic engage unit.

17. The variable part connection and separation system of claim 16, wherein the holder rotation part includes:
a lift arm hinge mounted on a lift arm which is provided to move up and down on a lift pillar of a lifter that separates the variable part from the frame or sets the variable part to the frame;
a coil holder hinge mounted on the coil holder;
a rotation part connecting pin connecting the lift arm hinge and the coil holder hinge; and
a rotation part motor that is connected to the rotation part connecting pin and selectively rotates the rotation part connecting pin.

18. The variable part connection and separation system of claim 12, further including a lifter that separates the variable part from the frame or sets the variable part to the frame.

19. The variable part connection and separation system of claim 18, further includes a lifter moving part engaged to the lifter for moving the lifter.

20. The variable part connection and separation system of claim 12, wherein the at least one magnetic engage unit includes:
an engage unit housing mounted on the variable part;
a fixed magnet mounted on the engage unit housing;
a control magnet rotatably mounted on the engage unit housing; and
a frame lower plate mounted on the frame and including a magnetic field passage formed in a lower position of the control magnet.
